(19) United States
(12) Patent Application Publication
(10) Pub. No.: US 2003/0231220 A1
(43) Pub. Date: Dec. 18, 2003

(54) Novel data processing method and system

(75) Inventors: Fumitaka Sase, Shinagawa (JP); Yuki Saga, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/289,292

(22) Filed: Nov. 7, 2002

(30) Foreign Application Priority Data
Jun. 14, 2002 (JP) 2002-173769

(51) Int. Cl. G09G 5/00

(52) U.S. Cl. 345/864; 345/749

(57) ABSTRACT

An object of this invention is to make the content that is not originally interactive have interactive and to make the content have relevance with other users. When a first predetermined portion within novel data is displayed, a display to prompt the user to input or select a keyword is carried out, and the inputted or selected keyword is registered. Besides, when a second predetermined portion within the novel data is displayed, the selection of a branch from the second predetermined portion to any one of predetermined branch destinations is prompted, and the selected branch destination data is registered. Then, data that includes the keyword and/or branch destination data and is associated with display control of the novel data is transmitted to a second user terminal in response to the user's instruction. Since it becomes possible to reproduce or display the branch route selected by a certain user and/or the keyword inputted by the certain user in the novel made to have interactive, even in a terminal of another user, it is possible for the users to enjoy one content from various angles.

### TECHNICAL FIELD OF THE INVENTION

This invention relates to a usage technique of the content, more particularly to an information processing technique in a case where the content, such as a novel, which is not originally interactive, is made interactive.

### BACKGROUND OF THE INVENTION

At present, the technology to enable a user to browse a novel or the like that is a non-interactive content by a terminal, such as a portable terminal, or to deliver the content, such as a novel, to the portable terminal and so on exists. On the other hand, a service, which provides online games that are originally interactive contents, exists.

It has tried to make the content that was a non-interactive interactive for some time. But, there was no case that it was taken into consideration to further make the content that is non-interactive have relevance with other users.

### SUMMARY OF THE INVENTION

Therefore, an object of this invention is to provide an information processing technology, which makes the content that is not originally interactive have interactive and makes the content have relevance with other users.

According to a first aspect of the invention, a novel data processing method comprises the steps of: performing a display to prompt a user to input or select a keyword when a predetermined portion within the novel data is displayed; storing the keyword inputted or selected by the user into a storage device; and transmitting data that includes the keyword and is associated with display control of the novel data, to a second user's terminal in response to a user's instruction.

Since it becomes possible to use the keyword inputted or selected in the novel made to have interactive, in the terminal of another user, it becomes possible for the users to enjoy one content in various points. Thereby, as for a service provider, the sales of the novel data are promoted, and the improvement in the profit can be expected.

Besides, according to a second aspect of the invention, a novel data processing method comprises the steps of: when a predetermined portion within the novel data is displayed, prompting a user to select a branch from branches from said predetermined portion to any one of predetermined branch destinations; storing branch destination data concerning the predetermined branch destination of the branch selected by the user into a storage device; and transmitting data that includes the branch destination data concerning the predetermined branch destination of the selected branch and is associated with display control of the novel data, to a second user's terminal in response to a user's instruction.

Since it becomes possible to reproduce the branch route selected by a certain user in the novel made to have interactive, even in the terminal of another user, it is possible for the users to enjoy one content from various angles. Thereby, the service provider expects that the sales of the novel data be promoted. Incidentally, saved data of the video game is not the data to reproduce the past game progress, but data to merely store the status or result of the past game progress. As for the content such as a novel, it is meaningless that he or she begins to read the novel from the middle of the story based on the others' status. But, it is meaningful to trace the branch route selected by the certain user and to confirm the story based on the branch route from the beginning.

Further, according to a third aspect of the invention, a novel data processing method comprises the steps of: receiving in response to a user's instruction and registering into a storage device, data that includes a keyword inputted or selected by another user and is associated with display control of the novel data and is generated in a terminal of another user; and reading out a keyword from the data that is associated with display control of the novel data and is stored in the storage device, and embedding the read keyword into a predetermined portion within the novel data to display the predetermined portion on a display device.

According to a fourth aspect of the invention, a novel data processing method comprises the steps of: receiving in response to a user's instruction and registering into a storage device, data that is associated with display control of the novel data and includes branch data for instructing a branch to a branch destination selected by another user from a predetermined portion within the novel data and is generated by a terminal of another user; and when the predetermined portion within the novel data is displayed, reading out branch destination data from the data that is associated with display control of the novel data and is stored in the storage device, and connectively displaying novel's data of a branch source and novel's data of the branch destination on a display device.

Incidentally, the aforementioned novel data processing method can be carried out by a program and a computer, and this program is stored in a storage medium or a storage device, for example, a flexible disk, a CD-ROM, a magneto-optical disk, a semiconductor memory, or a hard disk. Besides, there is also a case where the program is distributed through a network or the like as a digital signal. Incidentally, intermediate processing results are temporarily held in a memory.

### BRIEF DESCRIPTION OF THE DRAWINGS

FIG. 1 is a diagram showing a structure of a novel in one embodiment of the invention;

FIG. 2 is a conceptual diagram for a story divergence of the novel in one embodiment of the invention;

FIG. 3 is a diagram of a system outline in one embodiment of the invention;

FIG. 4 is a diagram showing an example of a ki1 table;

FIG. 5 is a diagram showing an example of an rt1 table;

FIG. 6 is a diagram showing an example of an rt2 table;

FIG. 7 is a functional block diagram of a reader applet;

FIG. 8 is a diagram showing data storage areas held in a user terminal;

FIG. 9 is a diagram showing an example of a first bookmark data;

FIG. 10 is a diagram showing an example of a second bookmark data;

FIG. 11 is a diagram showing the processing flow of a menu processing;

FIG. 12 is a diagram showing a screen example of a top menu;

FIG. 13 is a diagram showing the processing flow of a novel reading processing;

FIG. 14 is a diagram showing a screen example of a novel selection;

FIG. 15 is a diagram showing a screen example for displaying contents of the selected novel;

FIG. 16 is a diagram showing a screen example for selecting a series (the leading part in this case);

FIG. 17 is a diagram showing a screen example for confirming the series (the leading part in this case);

FIG. 18 is a diagram showing a screen example for determining a novel and series to be downloaded;

FIG. 19 is a diagram showing a first portion of the processing flow of a main processing;

FIG. 20 is a diagram showing a screen example of a normal state;

FIG. 21 is a diagram showing a second portion of the processing flow of the main processing;

FIG. 22 is a diagram showing the processing flow of a keyword input processing;

FIG. 23 is a diagram showing a screen example in a case where a ki1 tag exists;

FIG. 24 is a diagram showing a screen example after inputting a keyword corresponding to the ki1 tag;

FIG. 25 is a diagram showing the processing flow of a keyword display processing;

FIG. 26 is a diagram showing the processing flow in a case where a ki2 tag exits;

FIG. 27 is a diagram showing the processing flow of a route selection processing;

FIG. 28 is a diagram showing a screen example in a case where an rt1 tag exits;

FIG. 29 is a diagram showing the processing flow of an automatic route shift processing;

FIG. 30 is a diagram showing a screen example in a case where an rt2 tag exits;

FIG. 31 is a diagram showing the processing flow of a second keyword display processing;

FIG. 32 is a diagram showing a screen example in a case where a kill tag exits;

FIG. 33 is a diagram showing the processing flow of a volume change processing;

FIG. 34 is a diagram showing a screen example displayed when the next volume of the novel data is downloaded;

FIG. 35 is a diagram showing the processing flow of an infrared transfer processing of the bookmark data; and

FIG. 36 is a diagram showing a screen example in a case where the bookmark data is transmitted.

### DETAIL DESCRIPTION OF THE PREFERRED EMBODIMENTS

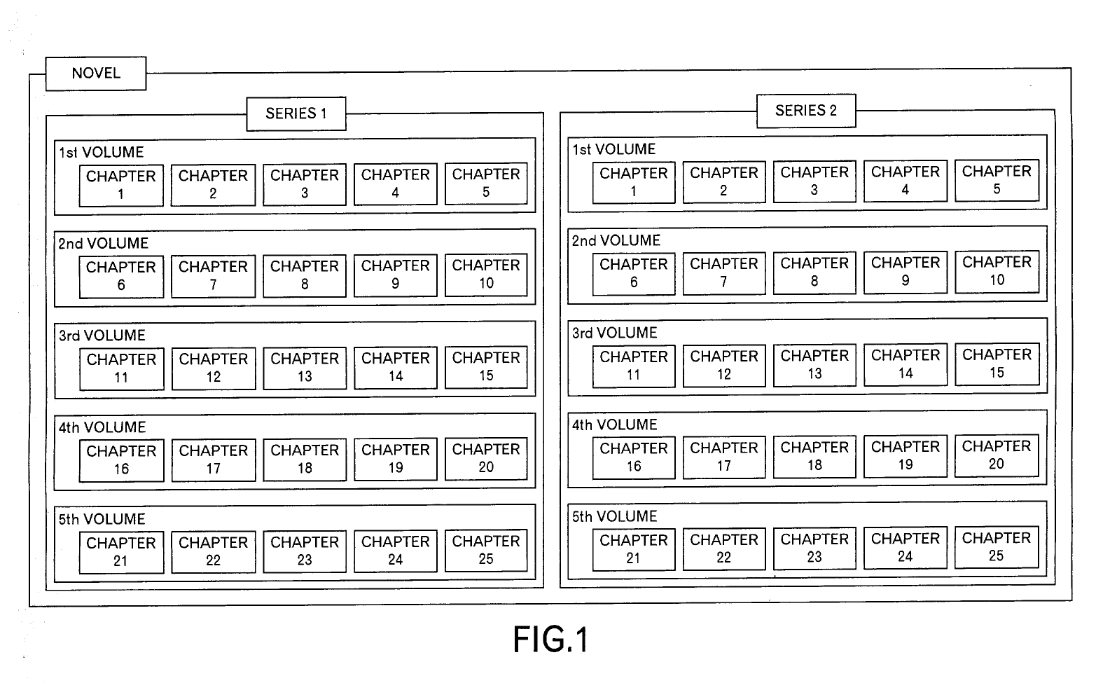

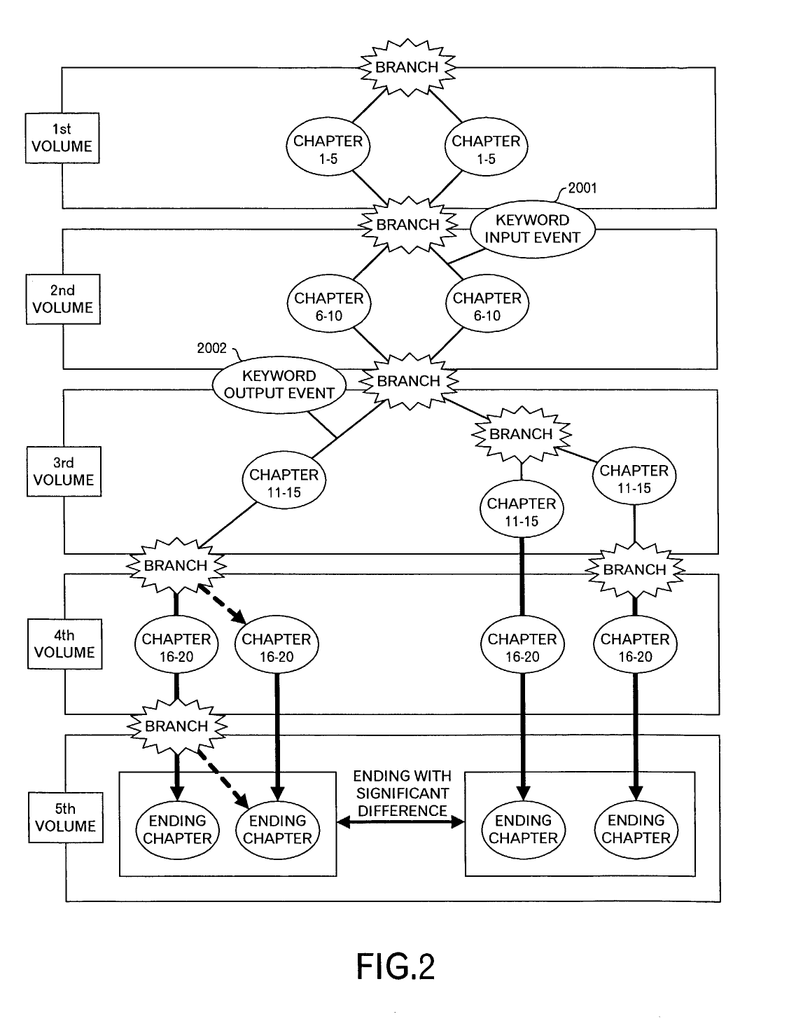

First, a novel according to one embodiment of this invention will be explained using FIGS. 1 and 2. A novel is the unit of the work of one writer, and one novel contains two series in this embodiment of the present invention, as shown in FIG. 1. The first series is the novel in which a man's character was written as a leading part, for example. The second series is the novel in which a woman's character was written as a leading part, for example. The flow of the main story is the same. A user chooses not only a novel itself, but also a series, when he or she subscribes. Each series contains five volumes, and one volume is composed of five chapters. A chapter is the minimum unit in the novel structure, and a branch occurs at the stage in which each chapter ends, for example. However, a branch is not set up in the fifth chapter of each volume.

It is possible to read the novel in a manner of tracing the basic story provided in the default, but other routes can be selected at the event of the branch to enjoy another story. Aside from the branch event, the events to input keywords such as a name are provided, and the user inputs information on the kind, which is prompted to input, such as a favorite name, food, and so on. Up to the end of the volume or the novel, the branch route and/or keywords selected or inputted by the user are stored in a storage device as bookmark data for the user. The bookmark data stored in the storage device is used at the positions other than the keyword input point. Besides, the user can obtain the bookmark data, which contains the branch route and/or keywords selected and/or inputted by another user for the same novel, from another user via infrared data communication, for example. Besides, the user can also transmit data, which contains the branch route and/or keywords selected and/or inputted by the user for the same novel, to another user via infrared data communication, for example. Thereby, it becomes possible for the user to read the novel with the viewpoint of another user. Besides, the story may be influenced when the user reads the novel according to the bookmark data of another user. Further, there is a case where a special chapter is provided, which can be read only when communicating with the terminal of another user via an infrared link.

FIG. 2 shows an outline diagram to explain the story development. For example, at a branch point, such as the end of a chapter, options of the branch destinations are presented to the user, and the user can cause the story to branch by selecting any one of the branch destinations. A mechanism in which the user can not know the route of the branch is adopted, and there is a case where it returns to the default story based on a selection manner of the branch destinations. For example, in the first volume, the view of the world in the story is the main thing, and the story never branches off drastically. In the second volume, branches concerning the progress of the story come to appear little by little. In the third volume, branch points that drastically influence the progress of the story appear. In the fourth volume, the fine-tuning after the route was determined is done. In the final chapter of the fifth volume, a branch point to make the stories have difference a little even at the ends with the same tendency is provided.

Moreover, an input event 2001 of a keyword is provided halfway, and the user is asked for the input of the favorite food, favorite name, or the like. The keyword inputted at the input event 2001 is outputted at a keyword output event 2002. As for the conclusion, at least two patterns are prepared as shown in FIG. 2, and the conclusion is made to change based on a selection manner of the branch destinations. Since the user can read one novel in various stories by selecting the branch destination at each branch point, it becomes possible to enjoy the novel many times.

Incidentally, FIG. 2 does not show such a case, but since the first to fourth volumes have a next volume, there is a case where the last chapter in one volume is set up as a neutral chapter, which is passed through even if any route is selected, to eliminate a sense of incongruity when moving to the next volume.

In this embodiment, bookmark data plays an important part. The user browses the novel as described above by using a reader, which is an applet by Java (trademark of Sun Microsystems Inc.), for example. The user terminal may be any kind of terminal, but here, a cellular phone is assumed, in which Java Virtual Machine (VM) is provided. When browsing, selection data of the branch destination at each branch point and keywords inputted or selected at the keyword input event are stored as the bookmark data in a storage area secured by the reader. Other than this data, a novel ID indicating what novel is read (in this embodiment, the novel ID includes a series ID to briefly explain. However, the series ID may be provided separately from the novel ID.), volume ID indicating what volume is read, cursor point indicating the last point of the cursor point at the previous browsing, and the like are stored into the storage area. Incidentally, not only one cursor point, but also a plurality of cursor points may be stored to enable the user to start reading from the plurality of cursor points.

Beside, the user can transmit his or her bookmark data to another user, and can also receive bookmark data from another user. When the bookmark data is received from another user, it is stored into the storage area with user's own bookmark data, and the user reads the novel under the influence of the bookmark of another user. However, the user can read the novel completely based on the bookmark data of another user. For the communication of the bookmark data, an infrared communication device provided in the cellular phone may be used, and a wireless communication device such as bluetooth may be used. Furthermore, it is also possible to transmit the bookmark data to another user in a manner of attaching it to E-mail.

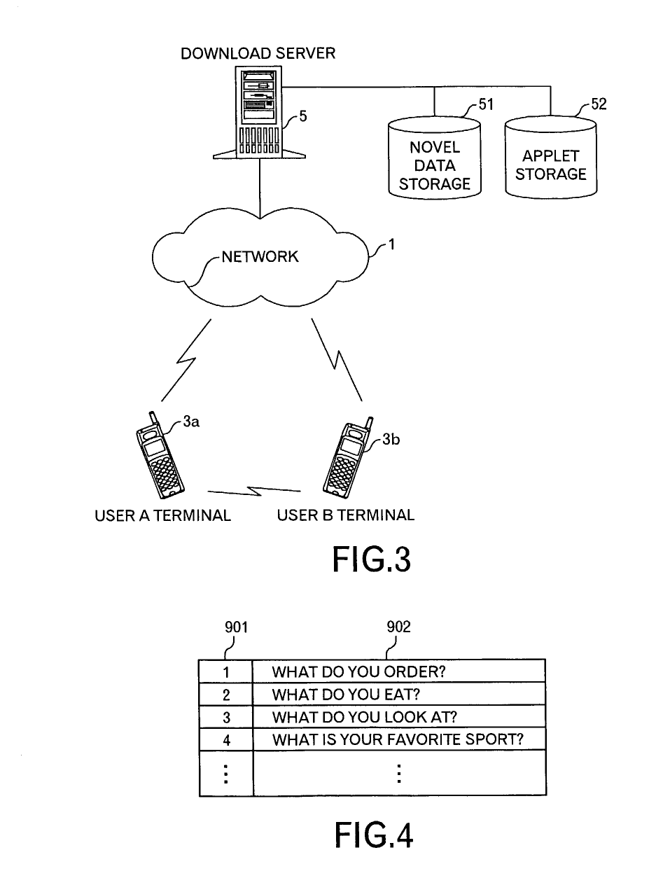

Next, a system outline according to one embodiment of this invention will be explained using FIG. 3. For example, a download server 5, which has a web server function and transmits novel data and/or a reader applet to a user terminal, is connected to a network 1, which is the Internet, for example. A company, which carries out a distribution service of novels, or a carrier manages and operates the download server 5. Besides, a user A terminal 3a and user B terminal 3b are connected to the network 1 via wireless communication. Incidentally, the user terminal is shown as a cellular phone in FIG. 3, but the user terminal is not limited to the cellular phone, and may be a Personal Digital Assistance (PDA) or notebook type personal computer. These types of user terminals have a web browser function, and Java VM for executing the reader applet, which is a Java applet, and is downloaded in advance. Moreover, it is assumed that the user terminals in this embodiment can directly communicate each other. For example, it is assumed that it has a wireless communication function such as an infrared wireless communication function or bluetooth (please refer to http://www.bluetooth.com in detail) or the like.

The download server 5 manages a novel data storage 51 and applet storage 52. The novel data storage 51 stores data (hereinafter, called novel data) of novels themselves, which can be browsed by, for example, the reader applet, default bookmark data used in the novel data, novel list data, volume list data for each novel, and the like. The default bookmark data is data including keywords and data of branch destinations, which are set up by a novelist for typical story development. The applet storage 52 stores information of the reader applet. In this embodiment, reader applets adjusted to functions of each cellular phone are held. In response to a download request from the user terminal, the download server 5 transmits an appropriate reader applet to the user terminal.

The novel data is structured so as to enable the user to browse the novel written by the novelist, by the reader applet, and includes data, for example, as follows:

[Table 1]

<Story>

Takashi went to a café, which was a meeting spot with Keiko, and sit down. Then, he ordered.

<ki1>1</ki1>

Then, one hour passed.

Takashi nervously waited for Keiko, who did not timely appear although the time to meet has already passed.

<rt1>1</rt1>

Keiko was working.

Her work did not end although the time to meet has already been passed.

Then, Keiko decided.

<rt2>1</rt2>

Keiko appeared.

“Hi, are you drinking <ki11>1</ki11>, aren't you?”

“Yeah, anyway, this is for you.”

Takashi handed over <ki2>2</ki2>, which Keiko had told she liked.

“You memorize it for me??”

Keiko was very glad.

</story>

Takashi was bewildered.

He intended to hand over <ki2>2</ki2>, specially.

</story>

Keiko called him.

“I can't go because of my work today.”

“All right.”

Takeshi said.

Takeshi was so disappointed that he steadily looked at <ki2>2</ki2>to be handed over to Keiko.

</story>

Here, the story start tag <story> represents the start of the story, and the story end tag </story> represents a delimiter for a chapter or a volume. The ki1 start tag <ki1> and ki1 end tag </ki1> represent an input portion of the keyword, and according to the value surrounded by these tags, the inquiry content to prompt to input the keyword varies. The rt1 start tag <rt1> and rt1 end tag </rt1> are tags for displaying options of the branch destinations, and according to the value surrounded by these tags, the configuration of the options of the branch destinations is changed. Besides, the rt2 start tag <rt2> and rt2 end tag </rt2> represent a branch point according to the default or another user's bookmark data, and according to the value surrounded by these tags, any of the branch destination data included in the bookmark data is determined to be used. The kill start tag <ki11> and kill end tag </ki11> represent a portion in which the keyword inputted at the portion of the ki1 tag is displayed, and according to the value surrounded by these tags, any one of inputted keywords is determined to be displayed. The ki2 start tag <ki2> and ki2 end tag </ki2> represent a portion at which a keyword is displayed based on the default or another user's bookmark, and according to these tags, any one of keywords is determined to be displayed.

In this embodiment, the novel data includes following data together with the data of the novel described above, for example. Namely, a ki1 table as shown in FIG. 4 is included in the novel data. An example of the ki1 table shown in FIG. 4 includes a column 901 of numeral values, and a column 902 of inquiry messages, and inquiry contents are registered correspondingly to each numeral value. In a case where “1” is instructed in the ki1 tag, a message “What do you order?” and a keyword input field are displayed.

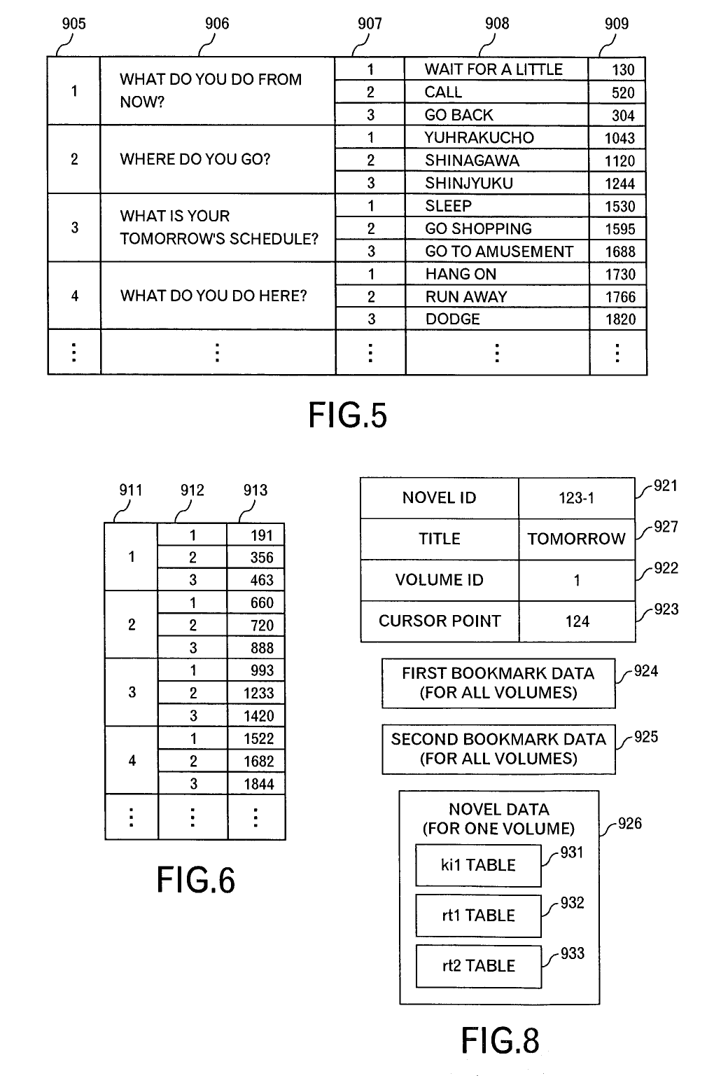

Besides, the novel data includes an rt1 table as shown in FIG. 5. An example of the rt1 table shown in FIG. 5 includes a column 905 of numeral values instructed in the rt1 tag, a column 906 of inquiry messages, a column 907 of option IDs, a column 908 of option contents, and a column 909 of cursor points of the branch destinations. For example, in a case where “1” is instructed in the rt1 tag, an inquiry message “What do you do from now?” and an inquiry including a message “wait for a little” whose option ID is “1”, a message “call” whose option ID is “2”, and a message “go home” whose option ID is “3” are displayed.

Furthermore, the novel data also includes an rt2 table as shown in FIG. 6. An example of the rt2 table shown in FIG. 6 includes a column 911 of numeral values instructed in the rt2 tag, a column 912 of option IDs, and a column 913 of cursor points of the branch destinations. For example, in a case where the numeral value instructed in the rt2 tag is “3” and the option ID is “2”, that is, another user selected a branch destination whose option ID is “2” at a branch point whose numeral value instructed in the rt1 tag is “3”, the cursor point is moved to “1233”.

When subscribing to a novel according to this embodiment, the user A first downloads the reader applet from the download server 5 to the user A terminal 3a, and instructs the reader applet to read the novel. The reader applet downloads necessary data of the novel in accordance with the instructions of the user A, and displays it on the display device of the user A terminal 3a. Incidentally, the user B instructs the user B terminal 3b similarly.

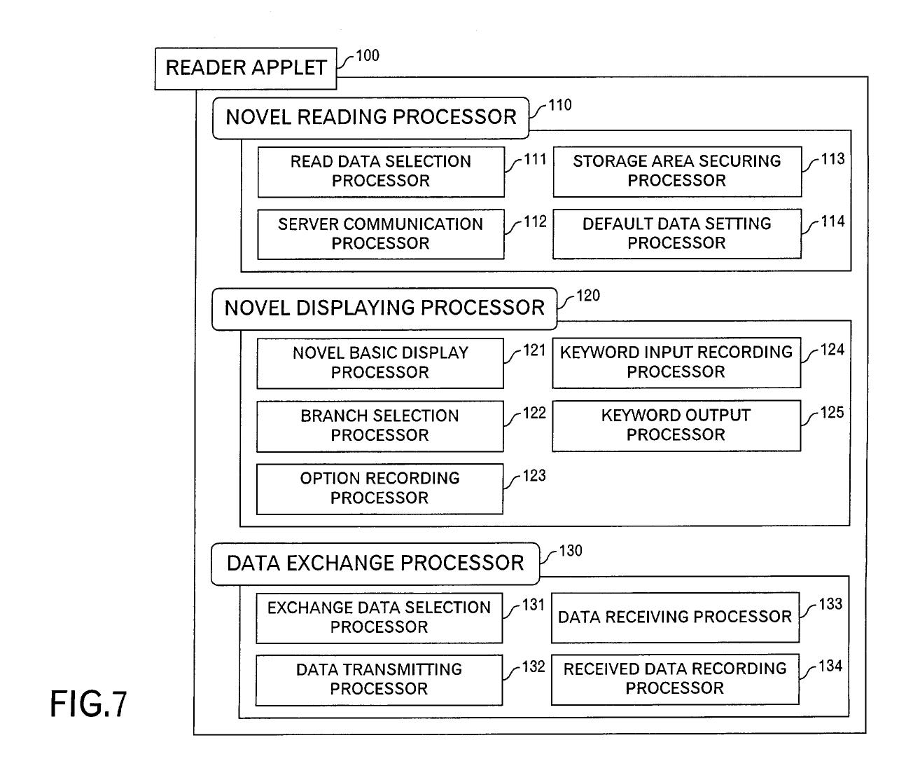

FIG. 7 shows a functional diagram of the reader applet. The reader applet 100 includes a novel reading processor 110, a novel displaying processor 120, and a data exchange processor 130. The novel reading processor 110 includes a read data selection processor 111, which causes the user to select data to be downloaded in communication with the download server 5, a server communication processor 112 for carrying out a communication processing with the download processor 5, a storage area securing processor 113 for securing storage areas for the novel data and other data within the user terminal, and a default data setting processor 114 for setting data of the default bookmark received from the download server 5. The novel displaying processor 120 includes a novel basic display processor 121 for carrying out a basic display of the novel data, a branch selection processor 122 for carrying out a processing for displaying branch options at each branch point according to the rt1 tag or the like, a option recording processor 123 for registering branch destination data corresponding to the option selected by the user, a keyword input recording processor 124 for carrying out a processing for prompting a keyword input according to the ki1 tag, and registering the inputted keyword into the storage area, and a keyword output processor 125 for carrying out a processing for displaying the keyword at the kill tag and/or the ki2 tag. The data exchange processor 130 is provided to transmit the bookmark data to another user, and to receive the bookmark data from another user, and includes an exchange data selection processor 131 for carrying out a display for causing the user to select the bookmark data to be sent, a data transmitting processor 132 for carrying out a processing for transmitting the bookmark data to be sent to the user terminal of another user, a data receiving processor 133 for carrying out a processing for receiving the bookmark data from another user's terminal, and a received data recording processor 134 for carrying out a processing for storing the received bookmark data of another user into a predetermined storage area.

FIG. 8 shows storage areas that are secured for the reader applet 100 in the storage device of the user terminal. In an example of FIG. 8, a storage area 921 for the novel ID of the novel data, which is held now, a storage area 927 for the title of the novel data, which is held now, a storage area 922 of the volume ID of the volume in the novel data, which is held now, a storage area 923 for the cursor point at the end of the previous browsing, a storage area 924 for the first bookmark data (for all volumes), a storage area 925 for the second bookmark data (for all volumes), and a storage area 926 for the novel data (for one volume). As described above, the novel data includes the ki1 table 931, rt1 table 932, and rt2 table 933. The first bookmark data is mainly bookmark data of the user himself or herself, and the second bookmark data is default bookmark data or another user's bookmark data. As for the novel data, only one volume of data is stored. This is because the user terminal such as the cellular phone has the limit of a memory capacity. However, if another type of user terminal is used, all volumes of the novel data may be stored regardless of that limit.

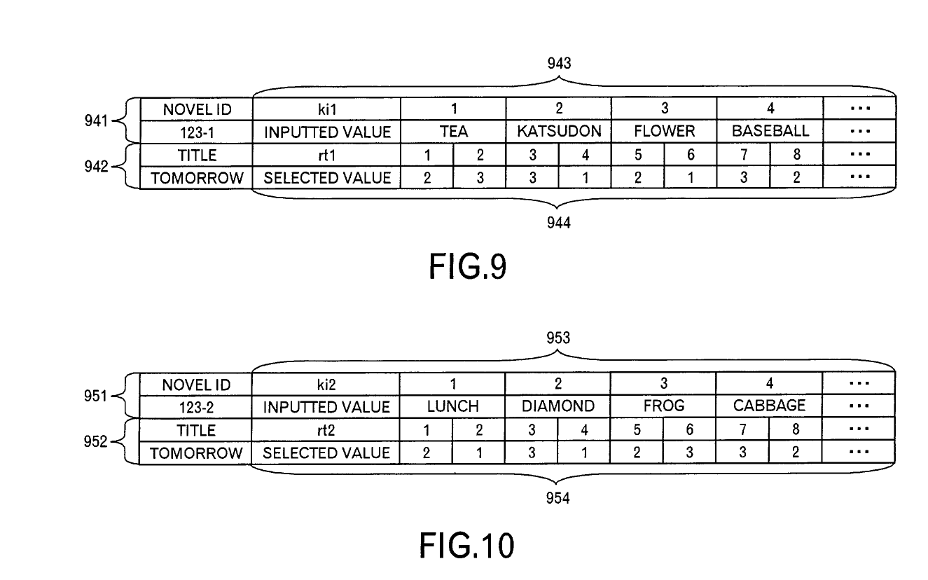

FIG. 9 shows an example of the first bookmark data. An example of the first bookmark data shown in FIG. 9 includes a novel ID 941, a title 942, a group 943 of pairs of numeral values instructed in the ki1 tag and inputted values inputted correspondingly to the ki1 tag, and a group 944 of pairs of numeral values instructed in the rt1 tag and option ID (selected value) selected correspondingly to the rt1 tag.

FIG. 10 shows an example of the second bookmark data. The included data is the same as the first bookmark data. An example of the second bookmark data shown in FIG. 10 includes a novel ID 951, a title 952, a group 953 of pairs of numeral values instructed in the ki1 tag and inputted values inputted correspondingly to the ki1 tag by another user or the like, and a group 954 of pairs of numeral values instructed in the rt1 tag and an option ID (selected value) selected correspondingly to the rt1 tag by another user or the like. However, the user terminal that uses the second bookmark data uses ki1 as ki2, and rt1 as rt2, and FIG. 10 shows ki2 and rt2.

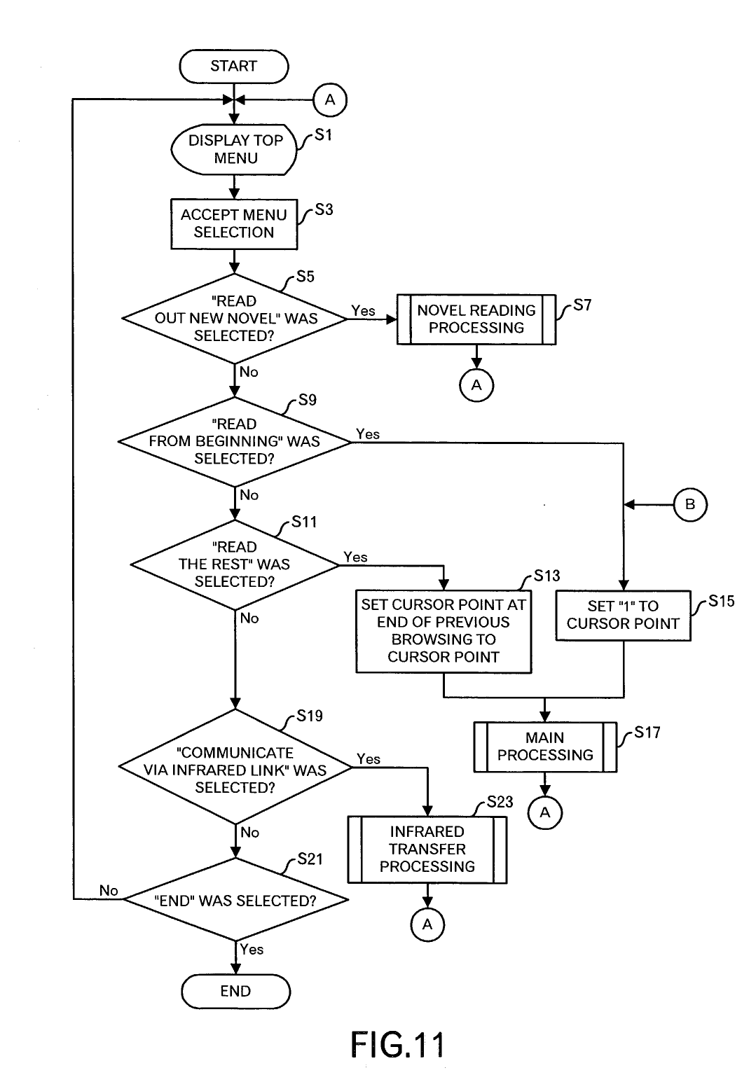

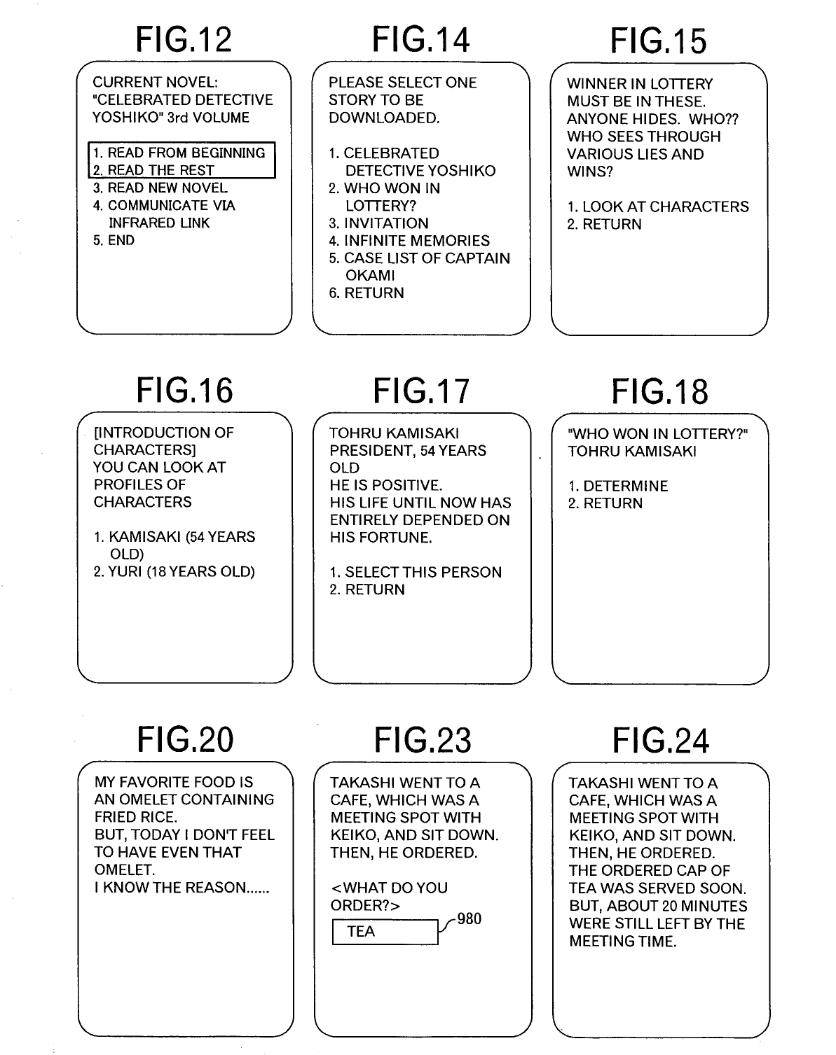

Next, a processing by the reader applet shown in FIG. 7 will be explained using FIGS. 11 to 36. Incidentally, the following explanation is performed on the assumption that the reader applet has already been downloaded into the user A terminal 3a. First, the reader applet 100 displays a top menu on the display device of the user A terminal 3a (step S1). For example, a screen as shown in FIG. 12 is displayed. An example of FIG. 12 includes a title (“Celebrated detective Yoshiko”, here) of the novel data already downloaded as a current novel and the volume ID (“third volume”, here). Besides, option menu items “read from beginning”, “read the rest”, “read out new novel”, “communicate via infrared link”, and “end” are included. The reader applet 100 accepts any selection input of the menu items by the user (step S3). Incidentally, “read from beginning” means “read from beginning of the volume”, and if he or she would like to read from the initial part of the novel, he or she must select “read out new novel”, here. Then, it is judged whether or not the item selected by the user is the item of “read out new novel” (step S5). If it is determined that the item of “read out new novel” was selected, a novel reading processing explained in detail later is carried out (step S7). Then, the processing returns to the step S1 via a terminal A.

On the other hand, if it is determined that the item of “read out new novel” was not selected, it is judged whether or not the item of “read from beginning” is selected (step S9). If it is determined that the item of “read from beginning” was selected, “1” is set to the current cursor point (step S15). Then, a main processing explained in detail later is carried out (step S17). After the step S17, the processing shifts to the step S1 via the terminal A.

Besides, if it is not determined that the item of “read from beginning” was selected, it is judged whether or not the item of “read the rest” was selected (step S1). If it is determined that the item of “read the rest” was selected, the cursor point (shown in FIG. 8) at the end of the previous browsing is set to the current cursor point (step S13). Then, the main processing is performed (step S17).

Furthermore, if it is determined at the step S11 that the item of “read the rest” was not selected, it is judged whether or not the item of “communicate via infrared link” was selected (step S19). If it is determined that the item of “communicate via infrared link” was selected, an infrared transfer processing explained in detail later is carried out (step S23). Then, after the step S23, the processing shifts to the step S1 via the terminal A.

If it is determined that the item of “communicate via infrared link” was not selected, it is judged whether or not the item of “end” was selected (step S21). If it is determined that the item of “end” was selected, the processing ends. If it is determined that the item of “end” was not selected, the processing returns to the step S1.

Thus, the user can instruct the desired processing from the menu.

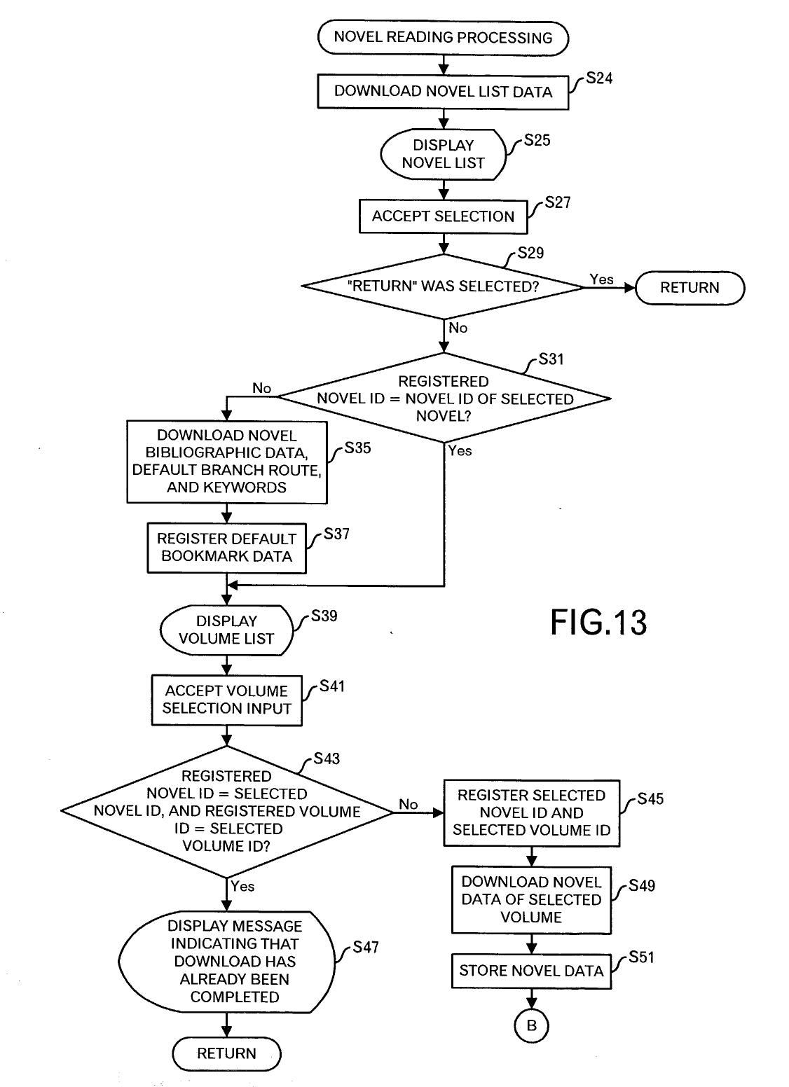

Next, the detail of the novel reading processing at the step S7 in FIG. 11 will be explained using FIG. 13. When the user selected the item of “read out the new novel”, the server communication processor 112 requests the novel list data for the download server 5, downloads the novel list data from the download server 5 (step S24), and temporarily stores it into the storage device. Then, the read data selection processor 111 displays the novel list by using the novel list data (step S25). FIG. 14 shows an example of the novel list display. In an example of FIG. 14, 5 novels are listed. Besides, an option to return to the main menu is included. The user selects and inputs any one of novels to be downloaded, or selects and inputs an item to return to the main menu. The read data selection processor 111 accepts the selection input by the user (step S27).

Incidentally, in the processing flow of FIG. 13, since the user must determine the novel to be downloaded based on only the title of the novel, there is a case where it is difficult for the user to determine. Therefore, as shown in FIG. 15, for example, there is a case where the outline of the selected novel is explained, and the transition to a page for explaining the characters is further enabled. In a case where the item of “look at characters” is selected in FIG. 15, a screen as shown in FIG. 16 is displayed. In an example of FIG. 16, a list of characters is included. For example, the list of characters includes the leading actor and actress. If “Kamisaki” is selected in FIG. 16, a screen shown in FIG. 17 is displayed. In FIG. 17, the character introduction of “Kamisaki” is carried out, and when the item of “select this person” is selected, a series whose leading actor is “Kamisaki” is selected. In FIG. 17, when the item of “select this person” is selected, a screen shown in FIG. 18 is displayed. An example of FIG. 18 includes the display of the novel name, the leading actor's name and options of “determine” and “return”. For example, when the item of “determine” is selected, the novel and series are determined. To simplify the explanation, at the step S25, the novel list including all series of the novels is displayed and any one is selected.

The read data selection processor 111 judges whether or not the selection input accepted at the step S27 was “return” (step S29). If it is determined that the selection input is “return”, the processing returns to the step S1 in FIG. 1. On the other hand, when any novel was selected, it is judged whether or not the novel ID of the novel currently held (registered novel ID shown in FIG. 8) is identical with the novel ID of the selected novel (step S31). Here, to simplify the explanation, it is judged whether or not the novel and series are identical. If it is determined that they are identical, the processing shifts to the step S39. On the other hand, if it is determined that they are not identical, the novel ID of the selected novel is held. Then, the server communication processor 112 transmits the novel ID of the selected novel to the download server 5, and downloads and stores into the storage device, novel bibliographic data (for example, novel ID, title, volume list data and the like), and a default branch route and keyword data for all volumes (hereinafter, called default bookmark data) (step S35). Here, the default bookmark data is bookmark data for all volumes. The storage area securing processor 113 secures the storage area 925 of the second bookmark data shown in FIG. 8, and the default data setting processor 114 registers the received default bookmark data into the storage area 925 (step S37).

Incidentally, there is a case where the same data is stored into the storage area 924 of the first bookmark data. In this way, the typical keywords and branch destination data can be presented to the user. When the user selects keywords and/or branch destinations different from the typical ones, they are overwritten as the first bookmark data.

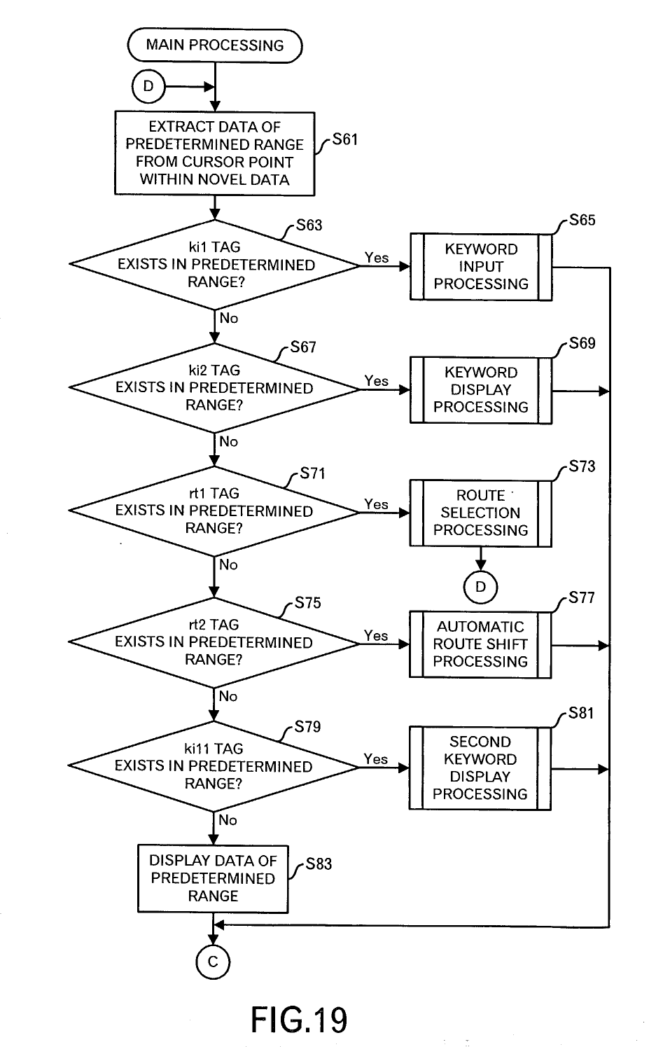

Then, the read data selection processor 111 displays the volume list on the display device by using the received novel bibliographic data (step S39). Here, it prompts the user to select any one of the first to fifth volumes to be read. The user inputs the volume selection. The read data selection processor 111 accepts the volume selection input from the user (step S41), and judges whether or not the novel ID (shown in FIG. 8) of the novel currently held and the novel ID of the novel selected at the step S27 are identical, and the volume ID of the stored volume in the novel currently held and the volume ID of the selected volume are identical (step S43). If it is determined that they are identical, this means that the download of the novel data that has been already downloaded to the user A terminal 3a is instructed. Therefore, the read data selection processor 111 displays a message indicating that the download has already been completed, on the display device (step S47), and the processing returns to the step S1 shown in FIG. 11. On the other hand, if it is determined that they are not identical, the novel ID of the selected novel and the volume ID of the selected volume are overwritten into the storage area 921 and 922 shown in FIG. 8 (step S45). Then, the server communication processor 112 transmits the novel ID and volume ID to the download server 5, and downloads the novel data corresponding to the novel ID and volume ID from the download server 5 (step S49). Then, the storage area securing processor 113 secures the storage area 926 of the novel data, and the default data setting processor 114 stores the received novel data into the storage area 926 (step S51). Then, the processing shifts to the step S15 in the processing shown in FIG. 19 via the terminal B.

In this way, in a case where a brand-new novel is selected and read, or in a case where a volume of a novel is read, then another volume is read, it becomes possible for the user to obtain the novel data of an appropriate volume.

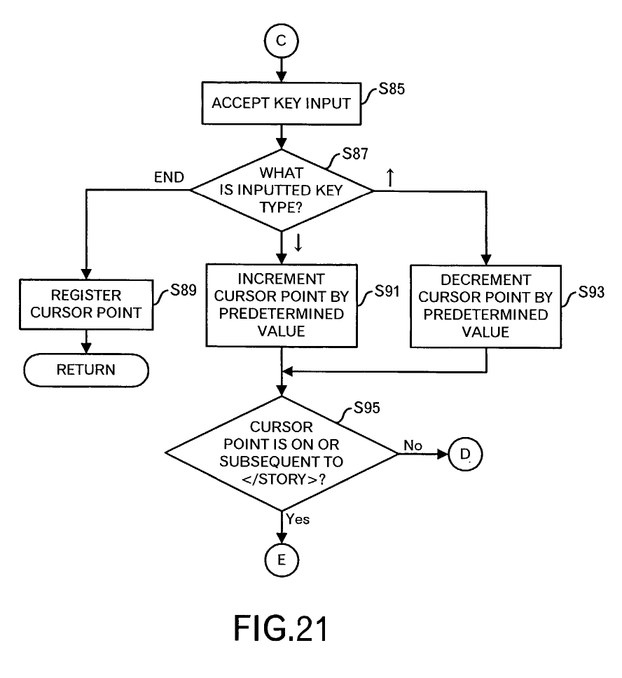

Next, the main processing at the step S17 in FIG. 11 will be explained using FIGS. 19 to 21. The novel basic display processor 121 extracts data of a predetermined range (for example, for one screen) from the current cursor point in the novel data (step S61). Then, it is judged whether or not there is a ki1 tag within the predetermined range from the current cursor point in the novel data (step S63). If the ki1 tag exists, the keyword input recording processor 124 carries out a keyword input processing explained in detail later (step S65). Then, the processing shifts to FIG. 21 via the terminal C. On the other hand, if the ki1 tag does not exit, it is judged whether or not there is a ki2 tag within the predetermined range from the current cursor point in the novel data (step S67). If the ki2 tag exists, the keyword output processor 125 carries out a keyword display processing explained in detail later (step S69). After that, the processing shifts to FIG. 21 via the terminal C.

If the ki2 does not exists, it is judged whether or not there is an rt1 tag within the predetermined range from the current cursor point (step S71). If the rt1 tag exists, the branch selection processor 122 and option recording processor 123 carry out a route selection processing explained in detail later (step S73). After that, the processing returns to the step S61 via the terminal D. Besides, if the rt1 tag does not exist, it is determined whether or not there is an rt2 tag within the predetermined range from the current cursor point (step S75). If it is determined that the rt2 tag exists, the branch selection processor 122 carries out an automatic route shift processing explained in detail later (step S77). Then, the processing shifts to FIG. 21 via the terminal C.

If the rt2 tag does not exist, it is judged whether or not there is a kill tag within the predetermined range from the current cursor point (step S79). If it is determined that the kill tag exists, the keyword output processor 125 carries out a second keyword display processing explained in detail later (step S81). After that, the processing shifts to FIG. 21 via the terminal C.

If the kill tag does not exist, the novel basic display processor 121 displays data of the predetermined range from the current cursor point on the display device (step S83). That is, if there is no tag described above, the data within the predetermined range is displayed. Incidentally, if the story end tag exists, data before it is displayed. For example, a screen as shown in FIG. 20 is carried out. Then, the processing shifts to a processing in FIG. 21 via the terminal C.

Next, a processing subsequent to the terminal C will be explained in FIG. 21. The novel basic display processor 121 waits a key operation by the user after the display. Then, when the user performs the key operation, it accepts the key input (step S85), and judges the kind of the inputted key (step S87). If it is determined that an upward arrow key was pushed, the current cursor point is decremented by a predetermined value (step S93). This is a case where the user reads the previous part again, and the predetermined value may be “1”, or a value for one line, several lines, or one page. Besides, if it is determined that a downward arrow key was pushed, the current cursor point is incremented by a predetermined value (step S91). This is a case where the user reads the next part, and the predetermined value is the same as in the upward arrow key was pushed. After the step S91 or S93, it is judged whether or not the current cursor point is on or subsequent to the story end tag (step S95). If it is determined that the current cursor point is on or subsequent to the story end tag, the processing shifts to FIG. 23 via the terminal E to carry out a volume update processing. On the other hand, if it is determined that the current cursor point is before the story end tag, the processing returns to the step S61 in FIG. 19 via the terminal D.

If it is determined at the step S87 that a key assigned to instruct the end was pushed, the current cursor point is registered into the storage area 923 of the cursor point (step S89). Then, the processing returns to step S1 in FIG. 11.

In this way, the user can read the novel.

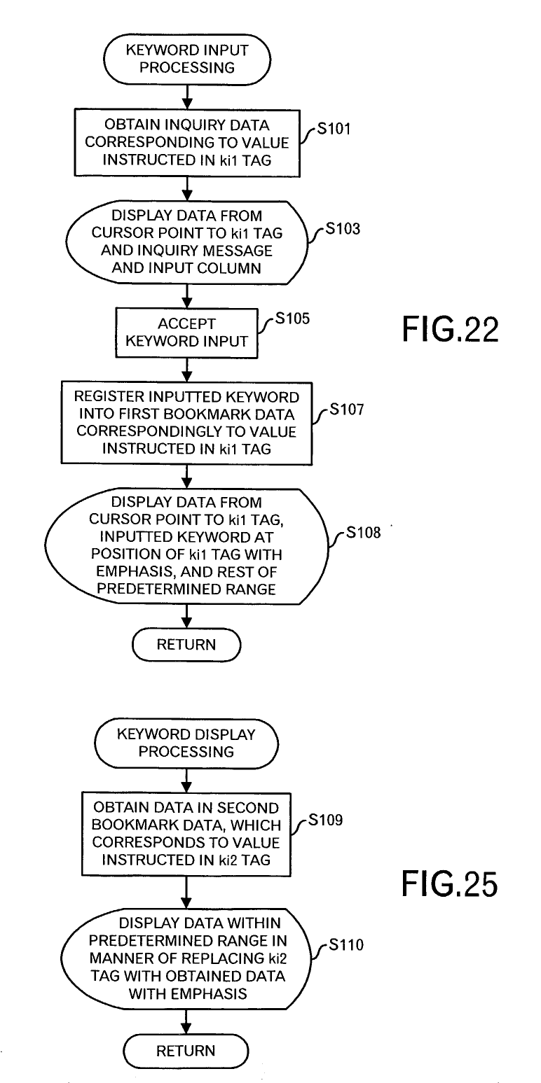

Next, the keyword input processing of the step S65 in FIG. 19 will be explained using FIG. 22. The keyword input recording processor 124 obtains inquiry data corresponding to the numeral value instructed in the ki1 tag from the ki1 table (FIG. 4) (step S101). In an example of the table 1, since “<ki1>l</ki1>” is represented, inquiry data corresponding to “1” is acquired from the ki1 table. Then, data from the current cursor point to the ki1 tag, an inquiry message based on the inquiry data, and a keyword input column are displayed on the display device (step S103). For example, a screen as shown in FIG. 23 is displayed. In an example of FIG. 23, normal sentences are included in the first half of the screen, and the inquiry message of “<<what do you order?>>” and the input column 980 are provided in the second half of the screen. Incidentally, here it is assumed that the user inputs “tea”. The keyword input recording processor 124 waits for the keyword input by the user, and accepts the keyword input by the user (step S105). Then, the inputted keyword is registered into the storage area 924 of the first bookmark data correspondingly to the numeral value instructed in the ki1 tag (step S107). Then, the novel basic display processor 121 displays data from the current cursor point to the ki1 tag, the inputted keyword at the position of the ki1 tag, and the rest of data within the predetermined rage from the current cursor point (step S108). Incidentally, the inputted keyword is displayed with emphasis (for example, it may be reversely displayed). Then, the processing shifts to the step S85 in FIG. 21 via the terminal C in FIG. 19.

In this way, the input of the keyword is accepted from the user, and is recorded as the first bookmark data. That is, the interactiveness of the novel is presented for the user, and the later use of the keyword and the transmission of the first bookmark data are prepared.

Incidentally, if any data is already stored as the first bookmark data, when the ki1 tag is detected, the keyword corresponding to the numeral value instructed in the ki1 tag is read out, and it may be displayed in the input column of FIG. 23 in a manner of enabling its modification, for example. In this way, what the novelist (if it is default) or another user inputted is clearly indicated.

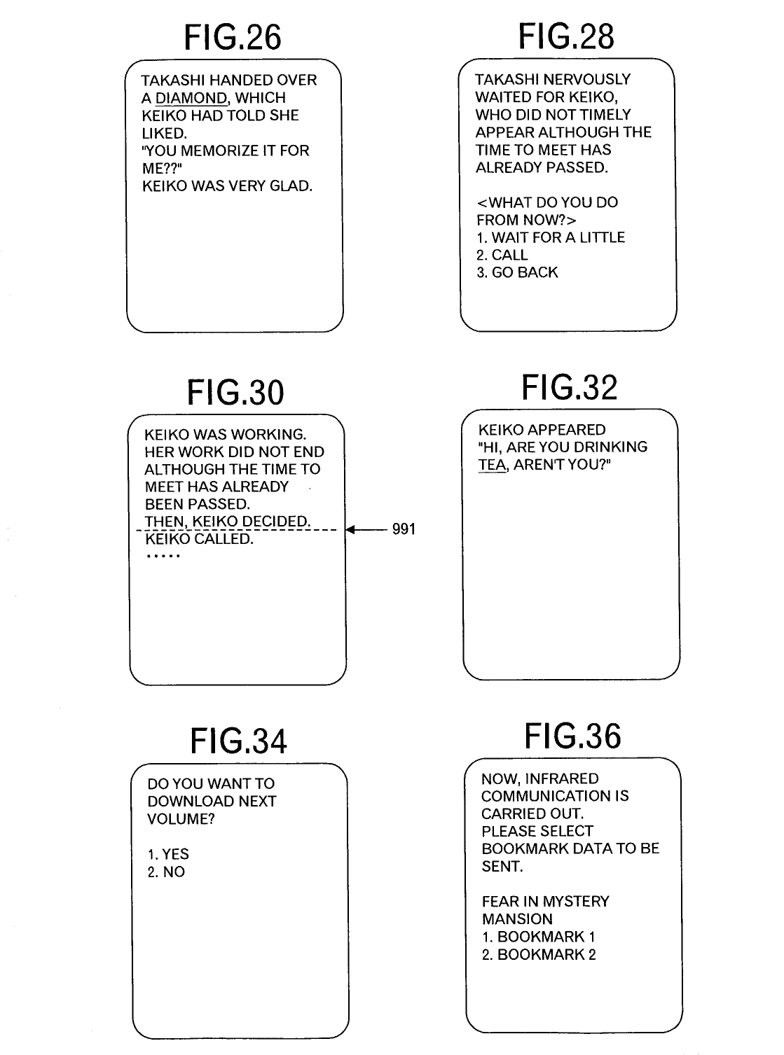

Next, the keyword display processing of the step S69 in FIG. 19 will be explained using FIG. 25. The keyword output processor 125 obtains data, which is within the second bookmark data and corresponds to the numeral value instructed in the ki2 tag (step S109). For example, since “<ki2>2</ki2>” is represented in the table 1, data corresponding to “2” is “diamond” in the second bookmark data shown in FIG. 10. Then, data within the predetermined range from the current cursor point is displayed on the display device in a manner of replacing the ki2 tag with the obtained data with emphasis (step S110). For example, a display example is shown in FIG. 26. As described above, the obtained “diamond” with an under line is inserted. Then, the processing shifts to the step S85 in FIG. 21 via the terminal C in FIG. 19.

The second bookmark data is the default bookmark data or another user's bookmark data. Therefore, if it is another user's bookmark data, since the keywords inputted by another user at the ki1 tags are used, the story of this user is changed based on another user's bookmark data.

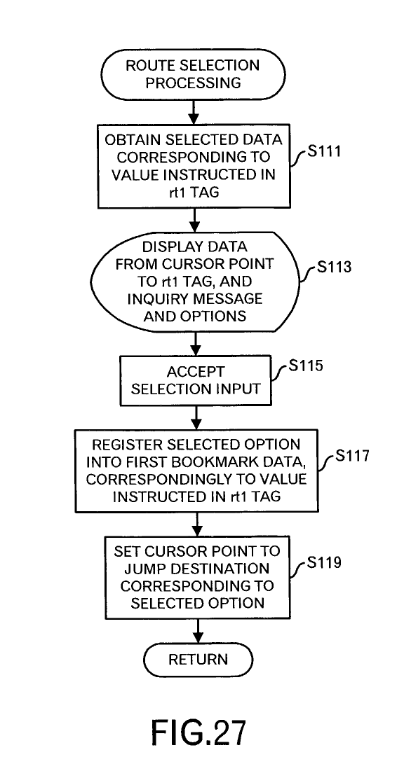

Next, the route selection processing of the step S73 in FIG. 19 will be explained using FIG. 27. The branch selection processor 122 obtains the selected data of the rt1 table shown in FIG. 5, which corresponds to the numeral value instructed in the rt1 tag (step S111). In an example of the table 1, since “<rt1>l</rt1>” is represented, data including “What do you do from now?”, and “1. wait for a little”, “2. call”, and “3. go home”, and respective cursor point values of corresponding branch destinations are obtained from the rt1 table. Then, the branch selection processor 122 displays the novel data from the cursor point to the rt1 tag, an inquiry message, and options obtained from the rt1 table on the display device (step S113). For example, a display as shown in FIG. 28 is carried out. The upper half is a portion in which the normal data is displayed, and the lower half includes the inquiry message and options obtained from the rt1 table.

The option recording processor 123 waits for a selection input from the user, and accepts the selection input by the user (step S115). Then, the selected option data is registered into the first bookmark data correspondingly to the numeral value instructed in the rt1 tag (step S117). For example, when “1” was selected, “1” is registered. Then, the current cursor point is set up at the jump destination corresponding to the selected option (step S119). For example, when “1” was selected, “130” is set to the current cursor point. Then, the processing returns to the step S61 via the terminal D in FIG. 19.

By doing so, the option data selected at each branch point is registered in the first bookmark data. This option data is used by another user when the first bookmark data is transmitted to another user later.

Incidentally, if any data is already stored in the first bookmark data, when the rt1 tag is detected, the option ID (selected value) corresponding to the numeral value instructed in the rt1 tag may be read out, and the option ID may be displayed at the option display portion in FIG. 28 with emphasis, for example. Thus, it is cleared which branch destination is selected by the novelist (if it is default) or another user.

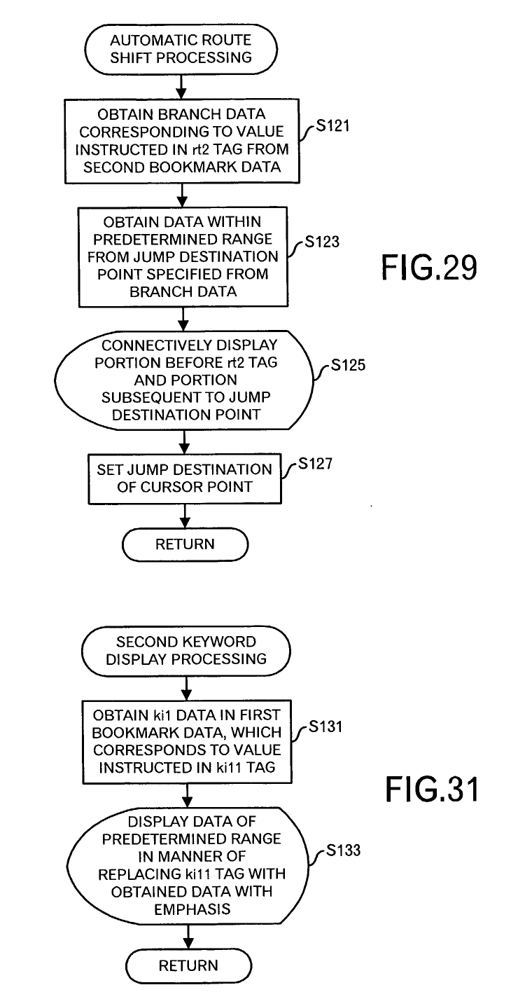

Next, the automatic route shift processing of the step S77 in FIG. 19 will be explained using FIG. 29. The novel basic display processor 121 obtains branch data corresponding to the numeral value instructed in the rt2 tag from the second bookmark data (step S121). In an example of the table 1, since “<rt2>1</rt2>” is represented, the branch data “2” corresponding to “1” is obtained from the second bookmark data. Besides, data within a predetermined range from the jump destination point (“346” in an example of FIG. 6), which is specified in the rt2 table from the branch data, is obtained (step S123). The predetermined range may be different from the predetermined range at the step S61 in FIG. 19. Besides, the predetermined range may vary in dependence on the character number from the cursor point to the rt2 tag. Then, the novel basic display processor 121 connects the data from the current cursor point to the rt2 tag and the data subsequent to the jump destination point, and displays it on the display device (step S125). For example, a display as shown in FIG. 30 is carried out. Here, the upper part above the line 991 represents sentences from the current cursor point to the rt2 tag and the portion under the line 991 represents the data subsequent to the jump destination point. Then, the jump destination of the current cursor point is set to the jump destination point specified in the rt2 table from the branch data (step S127). In this way, the current cursor point is changed in accordance with the branch route without inconsistency.

The second bookmark data is the default bookmark data or another user's bookmark data. Therefore, if it is another user's bookmark data, since it is the branch data selected by another user at the rt1 tag, the story of this user is changed based on another user's bookmark data.

The second keyword display processing in FIG. 19 will be explained using FIG. 31. The keyword output processor 125 acquires ki1 data in the first bookmark data, which corresponds to the numeral value instructed in the kill tag (step S131). In an example of the table 1, since “<ki11>1</ki11>” is represented, “tea” inputted for the ki1 tag in an example of FIG. 23 is obtained. Then, data within the predetermined range from the current cursor point is displayed on the display device in a manner of replacing the kill tag with the obtained data with emphasis (step S133). For example, a display as shown in FIG. 32 is carried out. Here, “tea” inputted in FIG. 23 is displayed with an under line.

In this way, the keyword input is accepted from the user, and is recorded as the first bookmark data. By using this keyword later, the interactiveness of the novel is presented to the user.

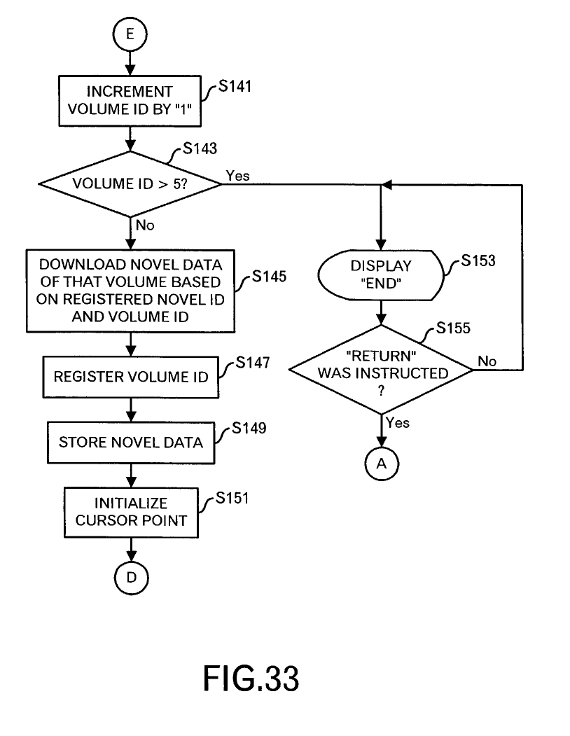

Next, a processing in a case where the processing shifts from the terminal E in FIG. 21 will be explained using FIG. 33. The read data selection processor 111 reads out the volume ID from the storage area 922 of the volume ID, and increments it by “1” (step S141). Then, it is judged whether or not the volume ID became greater than “5” (step S143). “5” is used because the volume number is 5, and it depends on the number of volumes. If the volume ID is 6, since it indicates that the user finished to read the novel, a display indicating the end of the novel is carried out (step S153). Then, the read data selection processor 111 waits for “return” instruction by the user. When the user instructs to “return”, the processing returns to the step S1 in FIG. 11 via the terminal A.

On the other hand, if the volume ID is less than “5”, the server communication processor 112 transmits the volume ID (in FIG. 8) of the novel currently held and the incremented volume ID to the download server 5, and downloads the novel data of that volume from the download server 5 (step S145). Incidentally, before this step, as shown in FIG. 34, it is also possible to inquire the user whether or not the next volume should be downloaded. For example, in a case where the user is charged for each volume of the novel data, or is charged for the communication, such inquiry may be preferable. Then, the storage securing processor 113 registers the new volume ID in the storage area 922 of the volume ID, and secures an area for the downloaded novel data. At this time, the novel data that has been held until now is deleted, and the storage area for that novel data is made free. Besides, the default data setting processor 114 stores the downloaded novel data into the storage area secured for that data (step S149). The read data selection processor 111 initializes the current cursor point to “1” (step S151).

By doing so, since next volume of the novel data is automatically downloaded when the user finished to read one volume, it is easy for the user to read the novel.

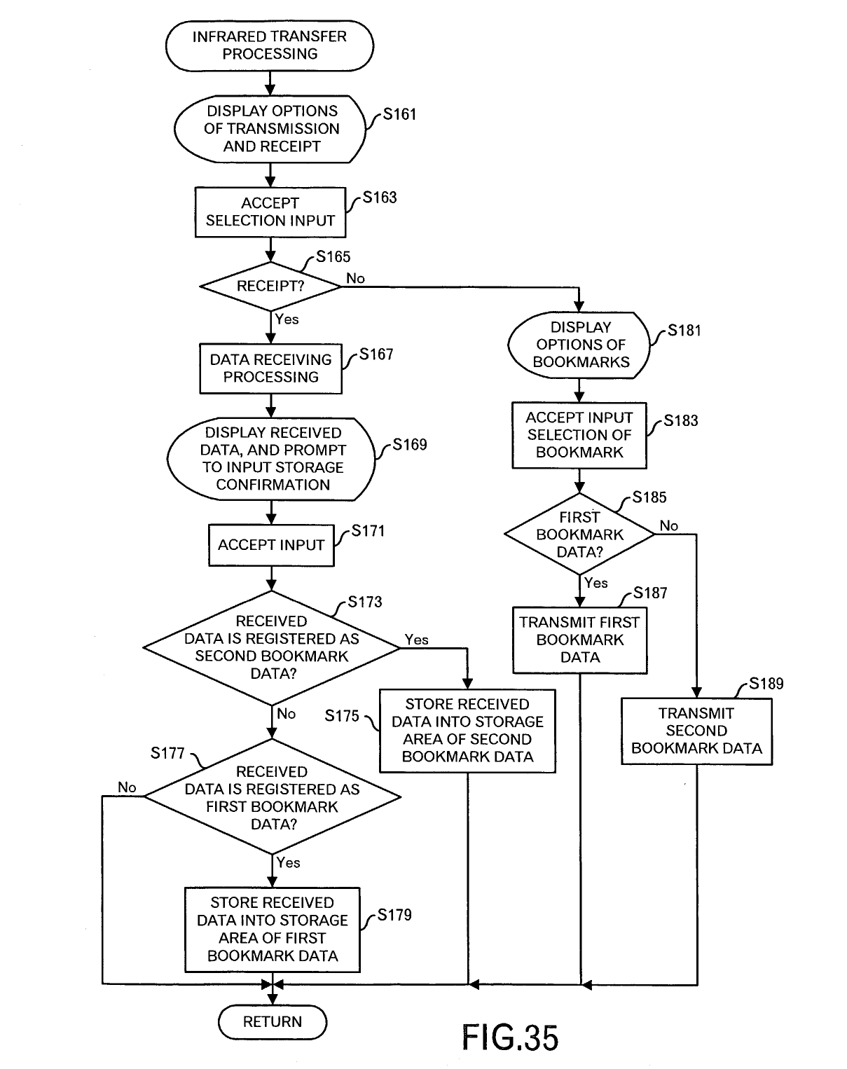

Next, the infrared transfer processing at the step S23 in FIG. 11 will be explained using FIG. 35. The exchange data selection processor 131 carries out a display to prompt the user to select the transmission or receipt on the display device (step S161). The exchange data selection processor 131 accepts the selection input (step S163), and judges whether or not the receipt was instructed (step S165). If it is determined that the receipt was instructed, the data receiving processor 133 performs a data receiving processing, and temporarily stores the received data into the storage device (step S167). Here, the infrared communication function provided in the user terminal is used to communicate with another user terminal.

The received data recording processor 134 carries out a display as to the received data by using the novel ID and the title included in the bookmark data, and prompts the user to input the storage confirmation of whether it is registered as the first bookmark data or as the second bookmark or it is not registered (step S169). The received data recording processor 134 waits for the input by the user, and accepts the input when the user inputs (step S171). Then, it is judged whether or not it was instructed that it was registered as the second bookmark data (step S173). If it is determined that it was instructed that it was registered as the second bookmark data, the received bookmark data is stored in the storage area 925 of the second bookmark data (step S175). Then, the processing returns to the step S1 via the terminal A. On the other hand, it is judged whether or not it was instructed that it was registered as the first bookmark data (step S177). If it is determined that it was instructed that it was registered as the first bookmark data, the received bookmark data is stored in the storage area 924 of the first bookmark data (step S179). Then, the processing returns to the step S1 via the terminal A. On the other hand, if it is determined at the step S177 that it was not instructed that it was registered as the first bookmark data, it means that the registration is quit. Therefore, the received data, which was temporarily stored in the storage device, is discarded, and the processing returns to the step S1 via the terminal A. Incidentally, if it is registered as the first bookmark data, his or her own current bookmark data will be discarded. Therefore, a display to make the user confirm the registration again may be carried out. Furthermore, it may be prohibited that it is stored as the first bookmark data. Besides, it is also possible to indicate an option to register the received data into both of the storage area 924 and 925 as the first and second bookmark data.

On the other hand, if the user instructed the transmission, the exchange data selection processor 131 carries out a display to cause the user to select either of the first and second bookmark data on the display device (step S181). For example, a display as shown in FIG. 36 is carried out. Here, it is asked to select either of the bookmark 1 and the bookmark 2. The exchange data selection processor 131 waits for the selection of the bookmark data by the user, and accepts the selection input by the user when it is inputted (step S183), and it is judged whether or not any one is selected (step S185). When the first bookmark data was selected, the data transmitting processor 132 reads out the first bookmark data from the storage area 924, and carries out a transmission processing (step S187). At this time, it is also possible to carry out a display indicating under the transmission. When the second bookmark data was selected, the data transmitting processor 132 reads out the second bookmark data from the storage area 925, and carries out a transmission processing (step S189). At this time, it is also possible to perform a display indicating under the transmission.

In this way, the user can exchange the bookmark data with another user, and enjoys the influence to the story according to the bookmark data inputted or selected by another user.

As described above, one embodiment of this invention was explained, but this invention is not limited to this embodiment. That is, for example, not only one download server 5, but also a plurality of download servers 5 may exist. Besides, the reader applet 100 and the novel data may be downloaded from different servers. Besides, in this embodiment, when the bookmark data is received from another user, the received bookmark data is simply overwritten in the storage area. However, it is also possible that the second bookmark data is changed after any operation is performed. For example, it is also possible to register the result of any operation between the second bookmark data and the received bookmark data in accordance with a predetermined rule.

Besides, if there is no limit of the capacity of the storage area, it is possible to download the novel data for a lot of volumes, not only one volume once. Besides, there is a case where data for a lot of novels is held in the user terminal. Screen examples described above are mere examples, and another screen configuration may be adopted.

When a ki1 tag is detected, the keyword input is asked in the above example. However, it is also possible to display keyword options and cause the user to select any one of the options.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A novel data processing method, comprising the step of:
performing a display to prompt a user to input or select a keyword when a predetermined portion within novel data is displayed;
storing said keyword inputted or selected by said user into a storage device; and
transmitting data that includes said keyword and is associated with display control of said novel data, to a second user's terminal in response to a user's instruction.

2. The novel data processing method as set forth in claim 1, further comprising a step of reading out and displaying said keyword stored in said storage device when a second predetermined portion within said novel data is displayed.

3. The novel data processing method as set forth in claim 1, further comprising the steps of:
receiving second data associated with the display control of said novel data from a third user's terminal; and
displaying said novel data by using said second data associated with the display control of said novel data.

4. The novel data processing method as set forth in claim 3, wherein said displaying step comprises a step of displaying a keyword included in said second data associated with the display control of said novel data at a third predetermined portion within said novel data.

5. The novel data processing method as set forth in claim 3, wherein said displaying step comprises a step of displaying novel's data at a branch source and novel's data at a branch destination, which are coupled according to branch destination data included in said second data associated with the display control of said novel data, when a fourth predetermined portion within said novel data is displayed.

6. The novel data processing method as set forth in claim 3, wherein said receiving step comprises a step of storing said second data associated with the display control within the novel data into a storage device, separately from said data associated with display control of said novel data by said user.

7. The novel data processing method as set forth in claim 3, wherein said receiving step comprises a step of overwriting said second data associated with the display control within said novel data on said data associated with display control of said novel data by said user.

8. A novel data processing method, comprising the steps of:
when a first predetermined portion within novel data is displayed, prompting a user to select one branch from branches from said first predetermined portion to any one of predetermined branch destinations;
storing branch data concerning said predetermined branch destination of said branch selected by said user into a storage device; and
transmitting display control data that includes said branch data concerning said predetermined branch destination of said selected branch and is associated with display control of said novel data, to a second user's terminal in response to a user's instruction.

9. The novel data processing method as set forth in claim 8, comprising the steps of:
performing a display to prompt a user to input or select a keyword when a second predetermined portion within novel data is displayed; and
storing said keyword inputted or selected by said user into a storage device, and
wherein said display control data includes said keyword.

10. The novel data processing method as set forth in claim 9, further comprising a step of reading out and displaying said keyword stored in said storage device when a third predetermined portion within said novel data is displayed.

11. The novel data processing method as set forth in claim 9, further comprising the steps of:
receiving second data associated with the display control of said novel data from a third user's terminal; and
displaying said novel data by using said second data associated with the display control of said novel data.

12. A novel data processing method, comprising the steps of:
receiving in response to a user's instruction and registering into a storage device, data that includes a keyword inputted or selected by another user and is associated with display control of novel data and is generated in a terminal of another user; and
reading out a keyword from said data that is associated with the display control of said novel data and is stored in said storage device, and embedding said keyword into a predetermined portion within said novel data to display said predetermined portion on a display device.

13. A novel data processing method, comprising the steps of:
receiving in response to a user's instruction and registering into a storage device, data that is associated with display control of novel data and includes branch data for instructing a branch to a branch destination selected by another user from a predetermined portion within said novel data and is generated by a terminal of another user; and
when said predetermined portion within said novel data is displayed, reading out branch destination data from said data that is associated with the display control of said novel data and is stored in said storage device, and connectively displaying novel's data at a branch source and novel's data at said branch destination on a display device.

14. A program embodied on a medium for causing a computer to perform a novel data processing, said program comprising the step of:
performing a display to prompt a user to input or select a keyword when a predetermined portion within novel data is displayed;
storing said keyword inputted or selected by said user into a storage device; and
transmitting data that includes said keyword and is associated with display control of said novel data, to a second user's terminal in response to a user's instruction.

15. The program as set forth in claim 14, further comprising a step of reading out and displaying said keyword stored in said storage device when a second predetermined portion within said novel data is displayed.

16. The program as set forth in claim 14, further comprising the steps of:
receiving second data associated with the display control of said novel data from a third user's terminal; and
displaying said novel data by using said second data associated with the display control of said novel data.

17. The program as set forth in claim 16, wherein said displaying step comprises a step of displaying a keyword included in said second data associated with the display control of said novel data at a third predetermined portion within said novel data.

18. The program as set forth in claim 16, wherein said displaying step comprises a step of displaying novel's data at a branch source and novel's data at a branch destination, which are coupled according to branch destination data included in said second data associated with the display control of said novel data, when a fourth predetermined portion within said novel data is displayed.

19. The program as set forth in claim 16, wherein said receiving step comprises a step of storing said second data associated with the display control within the novel data into a storage device, separately from said data associated with display control within said novel data by said user.

20. The program as set forth in claim 16, wherein said receiving step comprises a step of overwriting said second data associated with the display control within said novel data on said data associated with display control within said novel data by said user.

21. A program embodied on a medium for causing a computer to perform a novel data processing, said program comprising the steps of:
when a first predetermined portion within novel data is displayed, prompting a user to select one branch from branches from said first predetermined portion to any one of predetermined branch destinations;
storing branch data concerning said predetermined branch destination of said branch selected by said user into a storage device; and
transmitting display control data that includes said branch data concerning said predetermined branch destination of said selected branch and is associated with display control of said novel data, to a second user's terminal in response to a user's instruction.

22. The program as set forth in claim 21, comprising the steps of:
performing a display to prompt a user to input or select a keyword when a second predetermined portion within novel data is displayed; and
storing said keyword inputted or selected by said user into a storage device, and
wherein said display control data includes said keyword.

23. The program as set forth in claim 22, further comprising a step of reading out and displaying said keyword stored in said storage device when a third predetermined portion within said novel data is displayed.

24. The program as set forth in claim 22, further comprising the steps of:
receiving second data associated with the display control of said novel data from a third user's terminal; and
displaying said novel data by using said second data associated with the display control of said novel data.

25. A program embodied on a medium for causing a computer to perform a novel data processing, said program comprising the steps of:
receiving in response to a user's instruction and registering into a storage device, data that includes a keyword inputted or selected by another user and is associated with display control of novel data and is generated in a terminal of another user; and
reading out a keyword from said data that is associated with the display control of said novel data and is stored in said storage device, and embedding said keyword into a predetermined portion within said novel data to display said predetermined portion on a display device.

26. A program embodied on a medium for causing a computer to perform a novel data processing, said program comprising the steps of:
receiving in response to a user's instruction and registering into a storage device, data that is associated with display control of novel data and includes branch data for instructing a branch to a branch destination selected by another user from a predetermined portion within said novel data and is generated by a terminal of another user; and
when said predetermined portion within said novel data is displayed, reading out branch destination data from said data that is associated with the display control of said novel data and is stored in said storage device, and connectively displaying novel's data at a branch source and novel's data at said branch destination on a display device.

27. A novel data processing apparatus, comprising:
a display controller for performing a display to prompt a user to input or select a keyword when a predetermined portion within novel data is displayed;
a storage for storing said keyword inputted or selected by said user into a storage device; and
a transmitter for transmitting data that includes said keyword stored in said storage and is associated with display control of said novel data, to a second user's terminal in response to a user's instruction.

28. A novel data processing apparatus, comprising:
a display controller for prompting a user to select one branch from branches from a first predetermined portion to any one of predetermined branch destinations, when a first predetermined portion within novel data is displayed;
a storage device for storing branch data concerning said predetermined branch destination of said branch selected by said user; and
a transmitter for transmitting display control data that includes said branch data concerning said predetermined branch destination of said selected branch and is associated with display control of said novel data, to a second user's terminal in response to a user's instruction.

29. A novel data processing apparatus, comprising:
a receiver for receiving in response to a user's instruction and registering into a storage device, data that includes a keyword inputted or selected by another user and is associated with display control of novel data and is generated in a terminal of another user; and
a display controller for reading out a keyword from said data that is associated with the display control of said novel data and is stored in said storage device, and for embedding said keyword into a predetermined portion within said novel data to display said predetermined portion on a display device.

30. A novel data processing apparatus, comprising:
a receiver for receiving in response to a user's instruction and registering into a storage device, data that is associated with display control of novel data and includes branch data for instructing a branch to a branch destination selected by another user from a predetermined portion within said novel data and is generated by a terminal of another user; and
a display controller for reading out branch destination data from said data that is associated with the display control of said novel data and is stored in said storage device, and for connectively displaying novel's data at a branch source and novel's data at said branch destination on a display device, when said predetermined portion within said novel data is displayed.
